(19) United States
(12) Patent Application Publication
(10) Pub. No.: US 2013/0010092 A1
(43) Pub. Date: Jan. 10, 2013

(54) Polarized Panel System and Stereoscopic Video System

(76) Inventors: Chih-Li Wang, New Taipei City (TW); Ming-Jen Chan, New Taipei City (TW); Yi-Cheng Lee, New Taipei City (TW)

(21) Appl. No.: 13/525,341

(22) Filed: Jun. 17, 2012

(30) Foreign Application Priority Data
Jul. 5, 2011 (TW) 100123635

(51) Int. Cl. H04N 13/04

(52) U.S. Cl. 348/58; 348/E13.075

(57) ABSTRACT

The present disclosure discloses a polarized panel system. The polarized panel system includes a panel driving module and an active polarizer. The panel driving module includes a timing control unit, for generating a control signal according to an update frequency, a left-eye image signal and a right-eye image signal provided by a video signal. The active polarizer is coupled to the timing control unit, for alternatively operating between a first operating status and a second operating status. The active polarizer has a first polarization direction in the first operating status and a second polarization direction in the second operating status.

### BACKGROUND OF THE INVENTION

1. Field of the Invention

The present disclosure relates to a polarized panel system and a stereoscopic video system using the same, and more particularly, to a polarized panel system and a stereoscopic video system using the same for improving synchronization between an active polarizer and image displaying, to avoid crosstalk.

2. Description of the Prior Art

Generally speaking, the main principle of displaying stereoscopic image is letting left eye and right eye view different images. Via the difference of vision angles between left eye and right eye, the images respectively received by left eye and right eye are combined into a stereoscopic image having depth and layering in the head of users.

Taking polarized glasses as example, the principle of the polarized glasses is to utilize a left-circular polarizer and a right-circular polarizer as a left lens and a right lens of glasses, respectively, such that left eye and right eye of the user only can respectively view the left-circular and the right-circular polarized images. The display device sequentially projects the left-circular and the right-circular polarized images respectively received by left eye and right eye, such that the left-circular and the right-circular polarized images are combined into stereoscopic images in the head of the user via persistence of vision.

For example, after two projectors are equipped with respective polarizers in the front, and adjusted to project to the same position, left-eye images and right-eye images having different polarized direction are projected at the same position. Another method utilizes a high-update-rate projector for sequentially projecting left-eye images and right-eye images, and installs an active polarizer, such as Z-Screen, capable of switching polarized direction according to the frequency of projecting left-eye images and right-eye images in the front of the high-update-rate projector. As a result, the high-update-rate projector achieves the same effect as the two projectors without concern of adjusting the two projectors to project to the same position.

However, the prior art mostly utilizes the projectors to display the stereoscopic image, and the installation of the prior projectors is complex and expensive, and not suitable for family or personal usage. For this reason, the prior art really needs to be improved for expanding the application scope.

### SUMMARY OF THE INVENTION

The objective of the present disclosure is to provide a polarized panel system and a stereoscopic video system using the same for improving synchronization between active polarizer and image displaying, to avoid crosstalk.

The present disclosure discloses a polarized panel system, for receiving a video signal providing an update frequency, a left-eye image signal and a right-eye image signal. The polarized panel system comprises a panel driving module and an active polarizer. The panel driving module comprises a timing control unit, for generating a control signal according to the update frequency, the left-eye image signal and the right-eye image signal. The active polarizer is coupled to the timing control unit, for alternatively operating between a first operating status and a second operating status. The active polarizer has a first polarized direction in the first operating status and a second polarized direction in the second operating status.

The present disclosure further discloses a stereoscopic video system, capable of receiving a video signal, comprising an image generating device and a polarized panel system. The image generating device is utilized for providing an update frequency, a left-eye image signal and a right-eye image signal according to the video signal. The polarized panel system comprises a panel driving module and an active polarizer. The panel driving module comprises a timing control unit, for generating a control signal according to the update frequency. The active polarizer is coupled to the timing control unit, for alternatively operating between a first operating status and a second operating status according to the control signal. The active polarizer has a first polarized direction in the first operating status and a second polarized direction in the second operating status.

The present disclosure further discloses a stereoscopic video system, for receiving a video signal, comprising an image generating device and a polarized panel system. The image generating device comprises a processing module, for providing an update frequency and a control signal according to the video signal. The update frequency corresponds to a left-eye image signal and a right-eye image signal. The polarized panel system comprises an active polarizer, coupled to the processing module, for alternatively operating between a first operating status and a second operating status. The active polarizer has a first polarized direction in the first operating status and a second polarized direction in the second operating status.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a structure diagram of a stereoscopic video system according to an embodiment of the present disclosure.

FIG. 2 illustrates a schematic diagram of a polarized panel system according to an embodiment of the present disclosure.

FIG. 3 illustrates a schematic diagram of a stereoscopic video system according to an embodiment of the present disclosure.

FIG. 4 illustrates a schematic diagram of a stereoscopic video system according to another embodiment of the present disclosure.

FIG. 5 illustrates a schematic diagram of a stereoscopic video system according to another embodiment of the present disclosure.

### DETAILED DESCRIPTION

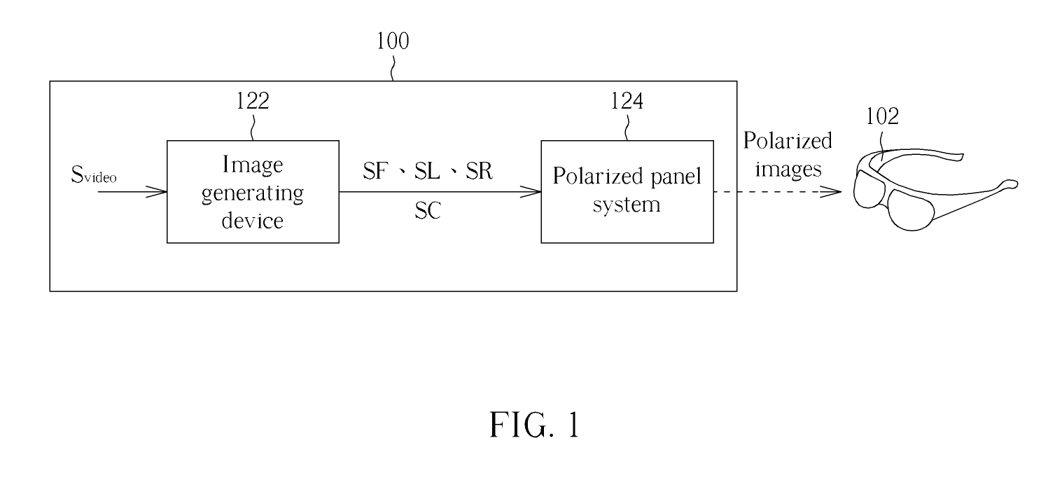

FIG. 1 illustrates a structure diagram of a stereoscopic video system 100 according to an embodiment of the present disclosure. The stereoscopic video system 100 includes an image generating device 122 and a polarized panel system 124. The image generating device 122 provides an update frequency SF, a left-eye image signal SL and a right-eye image signal SR to the polarized panel system 124 according to a video signal S_{video} for display. In addition, the image generating device 122 also provides a control signal SC to the polarized panel system 124. Therefore, the polarized panel system 124 alternatively displays between the left-eye images of polarized image according to the left-eye image signal SL and the right-eye images of polarized image according to the right-eye image signal SR, such that the user can utilize the polarized glasses 102 for combining the left-eye images and the right-eye images into stereoscopic images via persistence of vision, wherein the left lens and right lens of the polarized glasses 102 are respectively a left-circular and a right-circular polarized lens or other two orthogonal polarized lens, such as a horizontal and a vertical polarized lens.

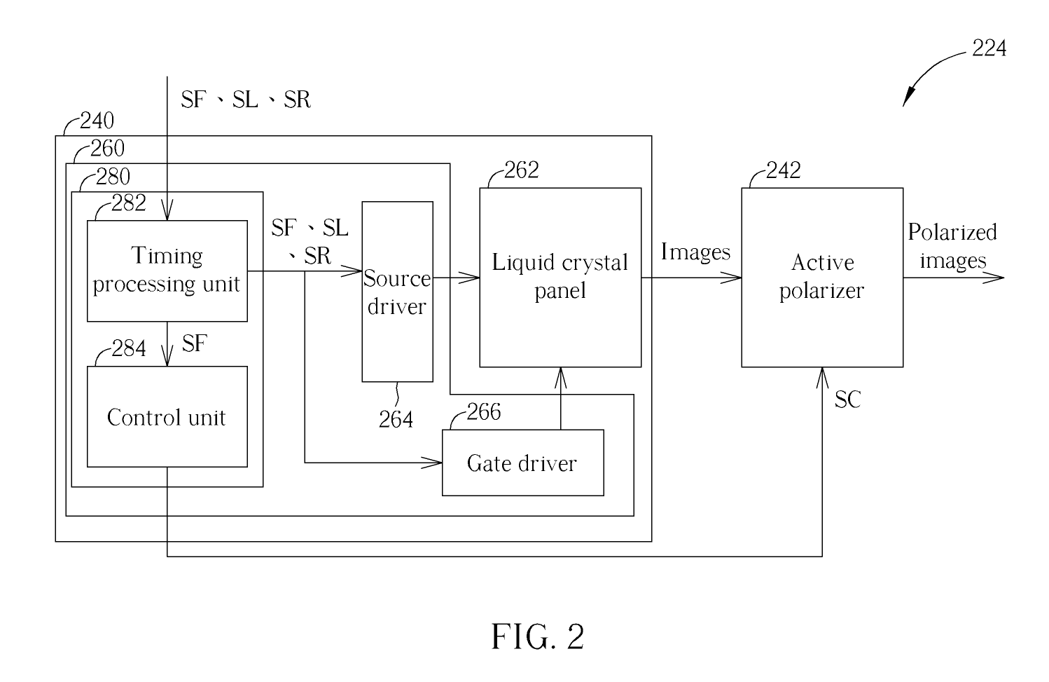

FIG. 2 illustrates a schematic diagram of the polarized panel system 224 according to an embodiment of the present disclosure. The polarized panel system 224 includes a liquid crystal display module 240 and an active polarizer 242. The liquid crystal display 240 includes a panel driving module 260, a liquid crystal panel 262, etc. The panel driving module 260 drives liquid crystal panel 262 for displaying the left-eye images and the right-eye images, and provides a control signal SC for controlling the active polarizer 242. The panel driving module 260 includes a source driver 264, a gate driver 266 and a timing control unit 280. The timing control unit 280 controls the source driver 264 and the gate driver 266 for driving the liquid crystal panel 262 according to the update frequency SF, the left-eye image signal SL and the right-eye image signal SF provided by the video signal S_{video}, such that the liquid crystal panel 262 alternatively displays between the left-eye images according to the left-eye image signal SL and the right-eye images according to the right-eye image signal SR. The timing control unit 280 generates a control signal SC for controlling the active polarizer 242.

In detail, the timing control unit 280 includes a timing processing unit 282 and a control unit 284. The timing processing unit 282 is utilized for processing the update frequency SF, such that the update frequency SF is corresponding to the left-eye image signal SL and the right-eye image signal SR. The control unit 284 generates the control signal SC according to the update frequency SF, such that the active polarizer 242, installed in the front of the liquid crystal panel 262, alternatively operates between an operating status OP1 and an operating status OP2. The active polarizer 242 has a left-circular polarized direction in the operating status OP1 and a right-circular polarized direction in the operating status OP2, or other two orthogonal polarized directions, such as horizontal and vertical polarized directions.

As can be seen from the above, via the update frequency SF corresponding to the left-eye image signal SL and the right-eye image signal SR, the control unit 284 generates the control signal SC for controlling the active polarizer 242 to operate in the operating status OP1 when the update frequency SF is corresponding to the left-eye image signal SL, and operate in the operating status OP2 when the updated frequency SF is corresponding to the right-eye image signal SR. In such a condition, after passing the active polarizer 242, the images displayed by the liquid crystal panel 262 are alternative switched between the left-circular and the right-circular polarized images.

In other words, when the liquid crystal panel 262 outputs the left-eye images, the active polarizer 242 synchronously switches to left-circular polarized direction according to the update frequency SF, such that the passed images become left-circular polarized images. Therefore, the left eye behind the left-circular polarizer can view the left-eye images, and the right eye behind the right-circular polarizer cannot view the left-eye images. When the liquid crystal panel 262 outputs the right-eye images, the active polarizer 242 synchronously switches to right-circular polarized direction according to the update frequency SF, such that the passed images become right-circular polarized images. Therefore, only the right eye behind the right-circular polarizer can view the right-eye images, and the left eye behind the left-circular polarizer cannot view the right-eye images. Finally, the user can view ideal the stereoscopic images via persistence of vision.

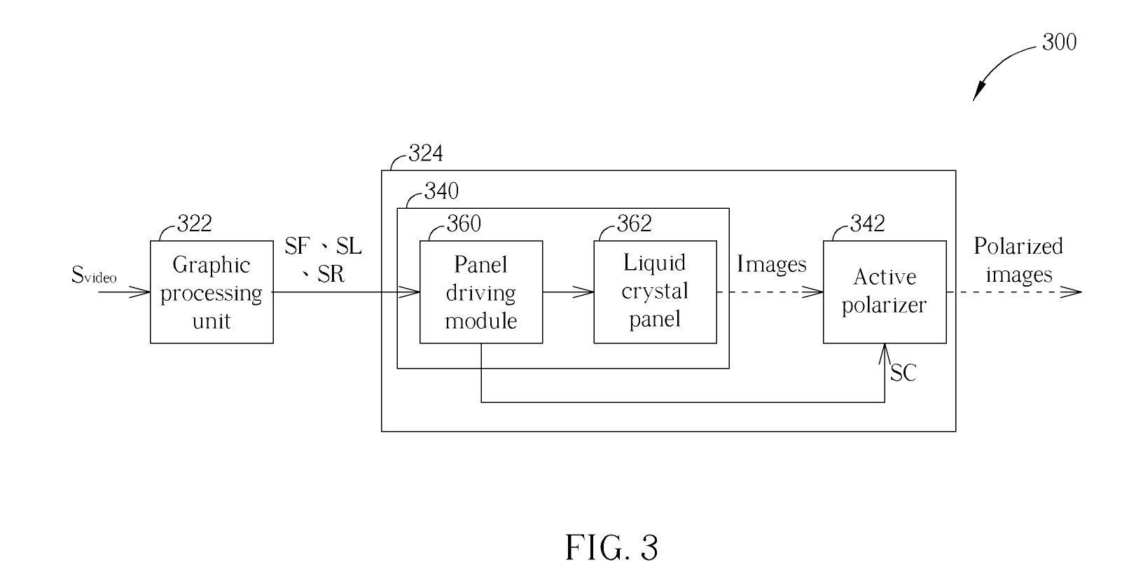

FIG. 3 illustrates a schematic diagram of a stereoscopic video system 300 according to an embodiment of the present disclosure. The stereoscopic video system 300 can be a computer system, e.g. a tablet, a notebook or an all-in-one computer, etc., but is not limited thereto. The stereoscopic video system 300 includes a graphic processing unit 322 and a polarized panel system 324. The graphic processing unit 322 provides a update frequency SF, a left-eye image signal SL and a right-eye image signal SR to the polarized panel system 324 according to a video signal S_{video} for display, wherein the video signal S_{video} is provided by a hard disk, a CD-ROM driver, a memory or a peripheral, e.g. a multimedia player, but is not limited thereto. The video signal S_{video} transmits the update frequency SF, the left-eye image signal SL and the right-eye image signal SR to the polarized panel system 324 through a low voltage differential signal (LVDS) interface. The update frequency SF, the left-eye image signal SL and the right-eye image signal SR also can be transmitted through an embedded displayport (eDP) interface, but not limited thereto.

The polarized panel system 324 is the same with the polarized panel system 224 shown in FIG. 2. As can be seen from the above, the panel driving module 360 drives the liquid crystal panel 362 to display the left-eye images and the right-eye images, and provides a control signal SC for controlling the active polarizer 342. The active polarizer 342, installed in the front of the liquid crystal panel 362, alternatively operates between the operating status OP1 and the operating status OP2. After passing the active polarizer 342, the left-eye images and the right-eye images, displayed by the liquid crystal panel 362, are alternatively switched between left-circular and right-circular polarized images. Finally, with the polarized glasses (not shown), the user can view the ideal stereoscopic images via persistence of vision.

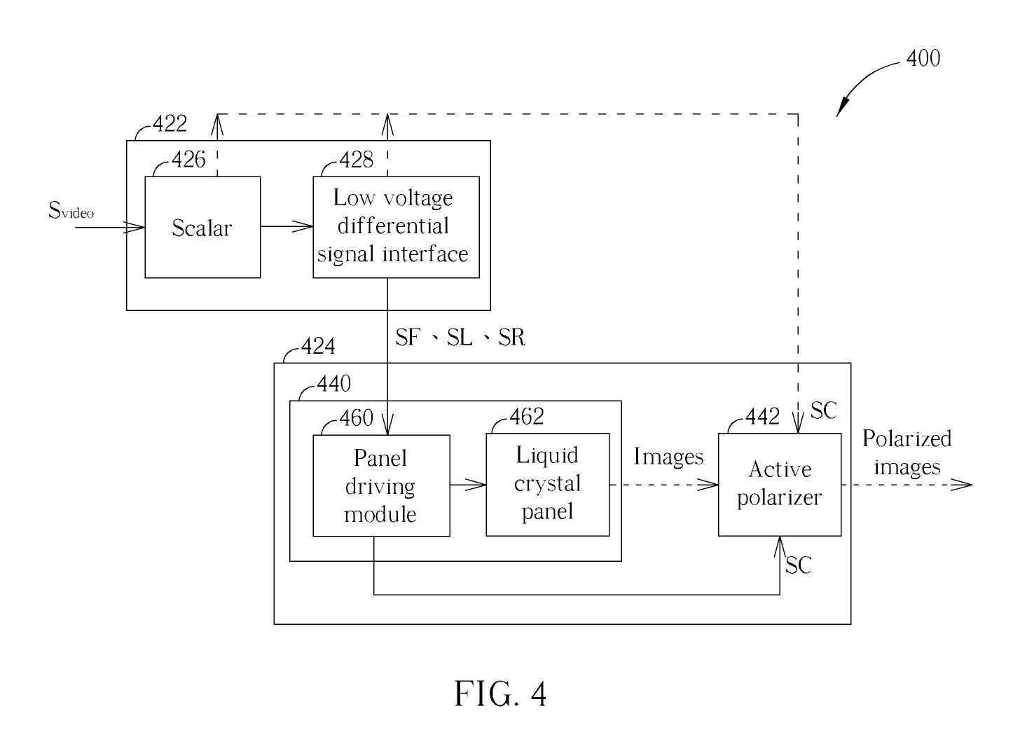

FIG. 4 illustrates a schematic diagram of a stereoscopic video system 400 according to an embodiment of the present disclosure. The stereoscopic video system 400 can be a television system or a display device, but is not limited thereto. The stereoscopic video system 400 includes a processing module 422 and a polarized panel system 424. The processing module 422 includes a scalar 426 and a low voltage differential signal interface 428. The scalar 426 executes image scaling control according to the video signal S_{video} for display, such that the low voltage differential signal interface 428 generates the update frequency SF, the left-eye image signal SL and the right-eye image signal SR complied with the transmission standard of the low voltage differential signal to the polarized panel system 424.

Similarly, the polarized panel system 424 is the same with the polarized panel system 224 shown in FIG. 2. As can be seen from the above, the panel driving module 460 of the polarized panel system 424 drives the liquid crystal panel 462 to display the left-eye images and the right-eye images, and provides a control signal SC for controlling the active polarizer 442. The active polarizer 442, installed in the front of the liquid crystal panel 462, alternatively operates between the operating status OP1 and the operating status OP2. The polarized panel system 424 alternatively displays the left-eye images and the right-eye images of the polarized images according to the update frequency SF, the left-eye image signal SL and the right-eye image signal SR, such that the user can view the stereoscopic images via polarized glasses (not shown). Noticeably, the control signal SC does not need to be transmitted to the active polarizer 442 through the panel driving module 460, but through the scalar 426 or the low voltage differential signal interface 428. Thus, the active polarizer 442 also can alternatively operate between the operating status OP1 and the operating status OP2 according to the control signal SC provided by the scalar 426 or the low voltage differential signal interface 428.

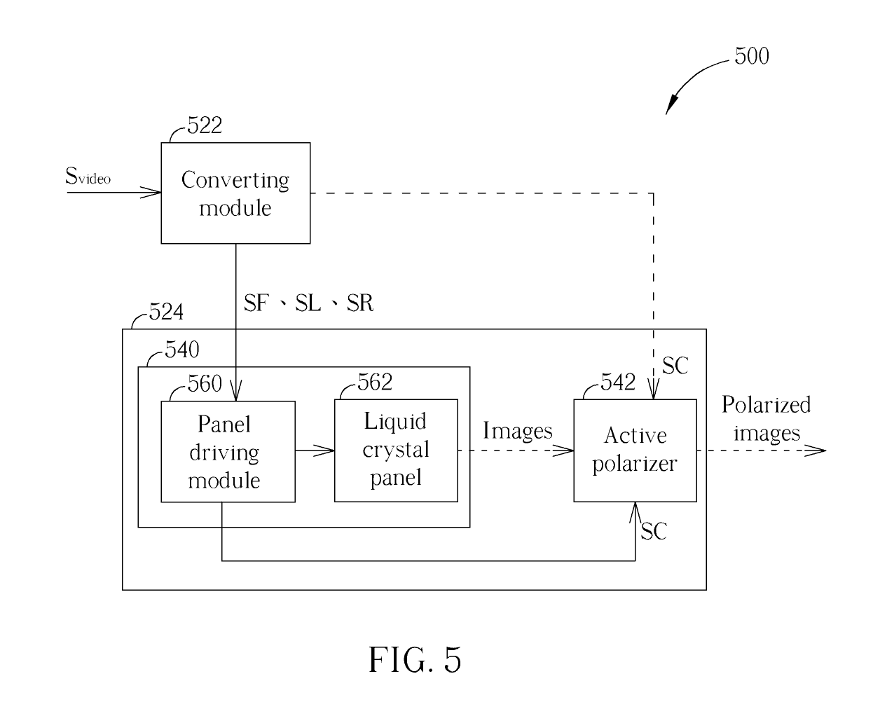

FIG. 5 illustrates a schematic diagram of a stereoscopic video system 500 according to an embodiment of the present disclosure. The stereoscopic video system 500 includes a video converter 520 and a polarized panel system 524. As shown in FIG. 5, the polarized panel system 524 can be a display device, such as a television, a computer, etc, and the video converter 520 is externally connected to the polarized panel system 524. In the video converter 520, whether the video signal S_{video} is a two-dimensional or a three-dimensional video signal, the video converter 520 converts the video signal S_{video} into the left-eye image signal SL and the right-eye image signal SR having three-dimensional image signal, and provides the update frequency SF, the left-eye image signal SL and the right-eye image signal SR to the polarized panel system 524.

As can be seen from the above, the panel driving module 560 of the polarized panel system 524 drives the liquid panel 562 to display the left-eye images and the right-eye images, and provides a control signal SC for controlling the active polarizer 542 to alternatively operate between the operating status OP1 and the operating status OP2. Besides, the control signal SC is not required to be provided to the active polarizer 542 through the panel driving module 560, but through the converting module 522. Finally, after passing the active polarizer 342, the left-eye images and the right-eye images, displayed by the liquid crystal panel 362, are alternatively switched between the left-circular and the right-circular polarized images. Finally, with the polarized glasses (not shown), the user can view the ideal stereoscopic images via persistence of vision.

The present disclosure allows the active polarizer to be applied in the computer system, e.g. the notebook, the all-in-one computer, and the television system. In addition, the source of the update frequency SF, for driving liquid crystal panel 262 to alternatively display between the left-eye images and the right-eye images, and the control signal SC, for controlling the active polarizer 242 to alternatively switching between the left-circular polarized direction and the right-circular polarized direction, is the same device, such as the timing control unit 282 or the image generating device 122, to enhance the synchronization between the liquid crystal panel 212 and the active polarizer 206, so as to avoid crosstalk.

The aforementioned are the embodiments of the present disclosure, the alternations and modifications according to the claims of the present disclosure should belong to the scope of the present disclosure. Those skilled in the art can accordingly modify or alter the present disclosure, and are not limited thereto. For example, the image generating device 122 also can transmit the update frequency SF, the left-eye image signal SL and the right-eye image signal SR to the polarized panel system 124 through a high definition multimedia interface (HDMI).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A polarized panel system, for receiving a video signal providing an update frequency, a left-eye image signal and a right-eye image signal, the polarized panel system comprising:
a panel driving module, comprising:
a timing control unit, for generating a control signal according the update frequency, the left-eye image signal and the right-eye image signal; and
an active polarizer, coupled to the timing control unit, for alternatively operating between a first operating status and a second operating status, having a first polarization direction in the first operating status and a second polarization direction in the second operating status.

2. The polarized panel system of claim 1, wherein the timing control unit comprises:
a timing processing unit, for processing the update frequency corresponding to the left-eye image signal and the right-eye image signal; and
a control unit, coupled to the timing control unit, for generating the control signal according the update frequency.

3. The polarized panel system of claim 1, wherein an image generating device provides the update frequency, the left-eye image signal and the right-eye image signal to the panel driving module according to the video signal.

4. The polarized panel system of claim 1, wherein the active polarizer operates in the first operating status when the update frequency corresponds to the left-eye image signal, and operates in the second operating status when the update frequency corresponds to the right-eye image signal.

5. The polarized panel system of claim 4, wherein the first polarization direction and the second polarization direction are orthogonal.

6. A stereoscopic video system for receiving a video signal, comprising:
an image generating device, for providing an update frequency, a left-eye image signal and a right-eye image signal according to the video signal.
a polarized panel system, comprising:
a panel driving module, comprising:
a timing control unit, for generating a control signal according to the update frequency; and
an active polarizer, coupled to the timing control unit, for alternative operating between a first operating status and a second operating status according to the control signal, having a first polarization direction when operating in the first operating status and a second polarization direction when operating in the second operating status.

7. The stereoscopic video system of claim 6, wherein the timing control unit comprises:
a timing processing unit, for processing the update frequency corresponding to the left-eye image signal and the right-eye image signal; and
a control unit, coupled to the timing processing unit, for generating the control signal according to the update frequency.

8. The stereoscopic video system of claim 6, wherein the active polarizer operates in the first operating status when the update frequency corresponds to the left-eye image signal, and operates in the second operating status when the update frequency corresponds to the right-eye image signal.

9. The stereoscopic video system of claim 8, wherein the first polarization direction and the second polarization direction are orthogonal.

10. The stereoscopic video system of claim 6, wherein the image generating device is a computer and further comprises a Graphics Processing Unit (GPU) for providing the update frequency, the left-eye image signal and the right-eye image signal to the panel driving module according to the video signal.

11. The stereoscopic video system of claim 10, wherein the image generating device transmits the update frequency, the left-eye image signal and the right-eye image signal to the panel driving module through a low voltage differential signal (LVDS) interface.

12. The stereoscopic video system of claim 10, wherein the image generating device transmits the update frequency, the left-eye image signal and the right-eye image signal to the panel driving module through a Embedded DisplayPort (eDP) interface.

13. The stereoscopic video system of claim 6, wherein the image generating device is a television and further comprises a processing module for providing the update frequency, the left-eye image signal and the right-eye image signal to the panel driving module according to the video signal.

14. The stereoscopic video system of claim 13, wherein the processing module further comprises a scalar for transmitting the update frequency, the left-eye image signal and the right-eye image signal to the low voltage differential signal interface.

15. The stereoscopic video system of claim 14, wherein the processing module further comprises a low voltage differential signal interface, for transmitting the update frequency, the left-eye image signal and the right-eye image signal to the panel driving module.

16. The stereoscopic video system of claim 13, wherein the processing module further comprises a scalar, for transmitting the update frequency, the left-eye image signal and the right-eye image signal to the panel driving module.

17. The stereoscopic video system of claim 6, wherein the image generating device is a image converter, for receiving the video signal and providing the update frequency, the left-eye image signal and the right-eye image signal to the panel driving module according to the video signal.

18. A stereoscopic video system, capable of receiving a video signal, comprising:
an image generating device, comprising a processing module, for providing an update frequency and a control signal according to the video signal, wherein the update frequency is corresponding to a left-eye image signal and a right-eye image signal.
a polarized panel system, comprising:
an active polarizer, coupled to the processing module, for alternative operating between a first operating status and a second operating status, having a first polarization direction in the first operating status and a second polarization direction in the second operating status.

19. The stereoscopic video system of claim 18, wherein the processing module further comprises a scalar, for transmitting the control signal to the active polarizer.

20. The stereoscopic video system of claim 18, wherein the processing module further comprises a low voltage differential signal interface, for transmitting the control signal to the active polarizer.

21. The stereoscopic video system of claim 18, wherein the active polarizer operates in the first operating status when the update frequency corresponds to the left-eye image signal, and operates in the second operating status when the update frequency corresponds to the right-eye image signal.

22. The stereoscopic video system of claim 21, wherein the first polarization direction and the second polarization direction are orthogonal.
